(19) United States
(12) Patent Application Publication
(10) Pub. No.: US 2005/0079767 A1
(43) Pub. Date: Apr. 14, 2005

(54) Memory card connector for mounting on a printed circuit board

(76) Inventors: Yi-Tse Ho, Bai-ho Gian (TW); Katsutoshi Tojo, Yamato-shi (JP)

Correspondence Address: MOLEX INCORPORATED, 2222 WELLINGTON COURT, LISLE, IL, 60532, US

(21) Appl. No.: 10/953,234

(22) Filed: Sep. 29, 2004

(30) Foreign Application Priority Data
Oct. 14, 2003 (TW) 92218265

(51) Int. Cl. H01R 12/00

(52) U.S. Cl. 439/630

(57) ABSTRACT

A memory card connector is provided for mounting on a main printed circuit board having a header connector thereon. The memory card connector includes an insulating housing having a rear terminal-mounting section and at least one longitudinal side wall section extending forwardly form one end of the rear section and combining therewith to define a card-receiving space. An array of terminals are mounted on the rear terminal-mounting section of the housing and have contact portions projecting into the space for engaging appropriate contacts on a memory card and tail portions exposed on the housing. An auxiliary printed circuit board is mounted on the housing and has an array of circuit traces electrically engaged with the tail portions of the terminals. The circuit traces on the auxiliary printed circuit board are electrically coupled to a mating connector on the board for mating with the header connector on the main printed circuit board.

### FIELD OF THE INVENTION

This invention generally relates to the art of electrical connectors and, particularly, to a memory card connector for mounting on a printed circuit board.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smartphones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

The memory card connector often is mounted on a printed circuit board. The memory card, itself, writes or reads via the connector and can transmit between electrical appliances, such as a word processor, personal computer, personal data assistant or the like. Typically, when a memory card connector is mounted on a printed circuit board, tail portions of the connector terminals are connected to appropriate circuit traces on the board. Most often the tail portions are surface mounted to the circuit traces by permanent solder connections, or the tail portions are inserted into holes in the printed circuit board and connected, as by soldering, to circuit traces on the board and/or in the holes. These permanent connections have disadvantages of not allowing for the memory card connector to be removed from the board and either replaced or repaired. Therefore, systems have been designed whereby the memory card connector is rigidly fastened to the board, and the terminal tail portions are held under pressure against the circuit traces on the board. This system has considerable disadvantages in that the connections between the tail portions and the circuit traces often are inadequate and can even separate if the board bends or warps, resulting in inferior or incomplete connections. The present invention is directed to solving these problems by an improved interconnection system between the memory card connector and the printed circuit board.

### SUMMARY OF THE INVENTION

An object, therefore, of the invention is to provide a new and improved system for mounting a memory card connector on a printed circuit board, the board having a header connector thereon.

In the exemplary embodiment of the invention, the memory card connector includes an insulating housing having a rear terminal-mounting section and at least one longitudinal side wall section extending forwardly form one end of the rear section and combining therewith to define a card-receiving space. An array of terminals are mounted on the rear terminal-mounting section of the housing and have contact portions projecting into the space for engaging appropriate contacts on a memory card and tail portions exposed on the housing. An auxiliary printed circuit board is mounted on the housing and has an array of circuit traces electrically engaged with the tail portions of the terminals. The circuit traces on the auxiliary printed circuit board are electrically coupled to a mating connector on the auxiliary board for mating with the header connector on the main printed circuit board.

As disclosed herein, an array of first terminals and an array of second terminals having respective contact portions for engaging appropriate contacts on first and second memory cards, respectively. The auxiliary printed circuit board has first and second arrays of circuit traces electrically engaged with the tail portions of the first and second terminals, respectively. In the preferred embodiment, the tail portions of the first terminals are electrically engaged with circuit traces on a top side of the auxiliary printed circuit board, and the tails portions of the second terminals are electrically engaged with circuit traces on a bottom side of the auxiliary printed circuit board.

According to one aspect of the invention, the housing includes a pair of rear side wall sections extending rearwardly from opposite ends of the rear terminal-mounting section and between which the auxiliary printed circuit board is mounted. The rear side wall sections have inwardly facing, opposing slots into which the auxiliary printed circuit board is inserted. Therefore, the auxiliary printed circuit board is mounted generally parallel to the main printed circuit board, with the mating connector on the auxiliary printed circuit board facing downwardly.

According to another aspect of the invention, a metal terminal cover is mounted over the rear of the housing. The auxiliary printed circuit board is mounted inside the metal terminal cover.

Other features of the invention include a metal baffle plate mounted on the housing in position between a pair of memory cards to provide electromagnetic interference protection between the first and second memory cards. The housing includes a plurality of through holes, and a plurality of fasteners penetrate through the holes and fix the connector to the main printed circuit board.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a bottom perspective view of a memory card connector according to the invention, along with an exploded depiction of a rear metal cover of the connector, the main printed circuit board and a pair of memory cards for insertion into the connector;

FIG. 2 is a top perspective view similar to that of FIG. 1, with the main printed circuit board omitted;

FIG. 3 is a bottom perspective view showing how the terminals are electrically connected to the auxiliary printed circuit board;

FIG. 3A is a top perspective view of the depiction of FIG. 3;

FIG. 4 is bottom perspective view of the connector, in conjunction with the main printed circuit board and showing fasteners for fixing the connector to the board; and

FIG. 5 is a perspective view showing the connector mounted in a support structure or chassis of an appropriate electrical appliance.

### DETAILED DESCRIPTION OF THE PREFERRED EMBODIMENT

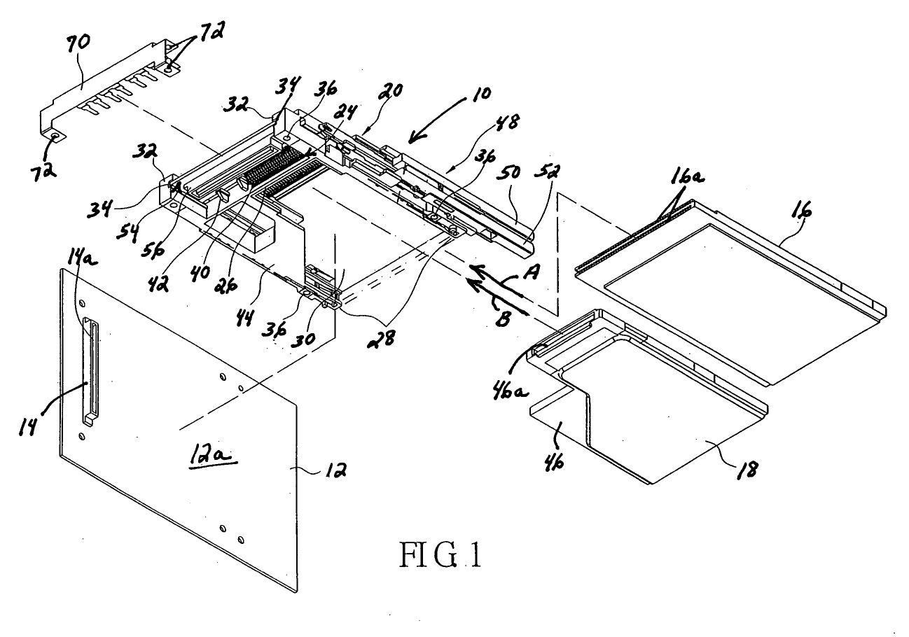

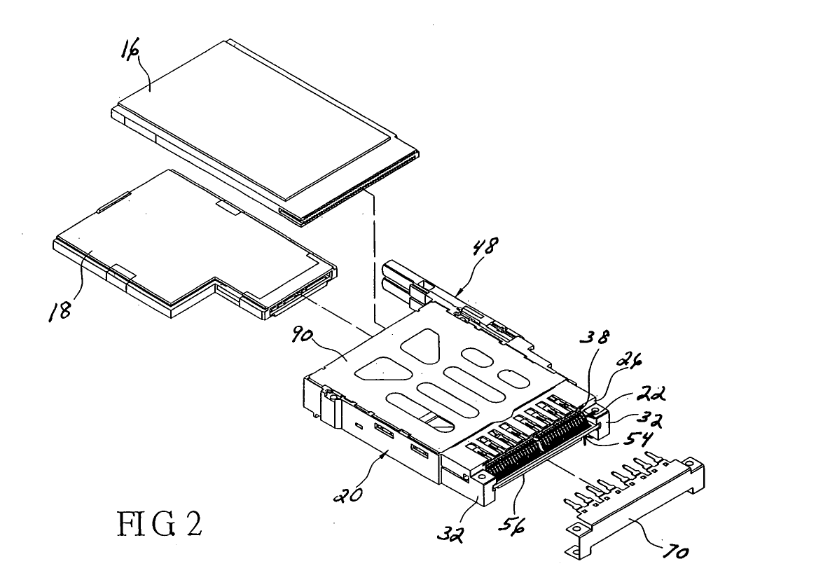

Referring to the drawings in greater detail, and first to FIGS. 1 and 2, the invention is embodiment in a memory card connector, generally designated 10, for mounting on a main printed circuit board 12. An elongated header connector 14 is mounted on a top surface 12a of the main printed circuit board. The memory card connector is designed for receiving either one or both of two different memory cards: namely, a first or top memory card 16 insertable into the connector in the direction of arrow [symbol] A [symbol] , and a second or bottom memory card 18 inserted into the connector in the direction of arrow [symbol] B [symbol] . The connector includes an insulating or dielectric housing, generally designated 20, which mounts a cross-linear array of first terminals, generally designated 22, for electrical connection with first memory card 16, and a cross-linear array of second terminals, generally designated 24, for electrical connection with second memory card 18.

More particularly, housing 20 of memory card connector 10 includes a rear terminal-mounting section 26 and a pair of side wall sections 28 which extend forwardly from opposite ends of the rear section to form a generally U-shaped configuration which defines a card-receiving space for receiving memory cards 16 and 18. A metal baffle plate 30 is mounted within slots in the inside faces of side wall sections 28 in position between a pair of inserted memory cards to provide electromagnetic interference protection between the cards. A pair of rear side wall sections 32 extend rearwardly from opposite ends of the rear terminal-mounting section 26. Rear side wall sections 32 have inwardly facing, opposing slots 34 for purposes described hereinafter. The housing has a plurality of vertical through holes 36 for receiving fasteners as described hereinafter. Rear section 26 of the housing has a plurality of terminal-receiving passages 38 (FIG. 2) for mounting first terminals 22, and a plurality of terminal-receiving passages 40 (FIG. 1) for mounting second terminals 24. As seen in FIG. 1, the rear section of the housing has a pair of rearwardly projecting supports 42, for purposes described hereinafter. Finally, the housing has a generally triangularly shaped, slotted support 44 (FIG. 1) which projects forwardly from the rear section of the housing inside one of the side wall sections 28 for receiving a generally triangularly configured tab 46 on second memory card 18.

Connector 10 also includes an eject mechanism, generally designated 48, mounted on one of the side wall sections 28 of the housing. The eject mechanism includes a pair of independently operable ejecting arms 50 and 52 for ejecting one or both of the two memory cards 16 and 18, respectively, which are insertable into the connector.

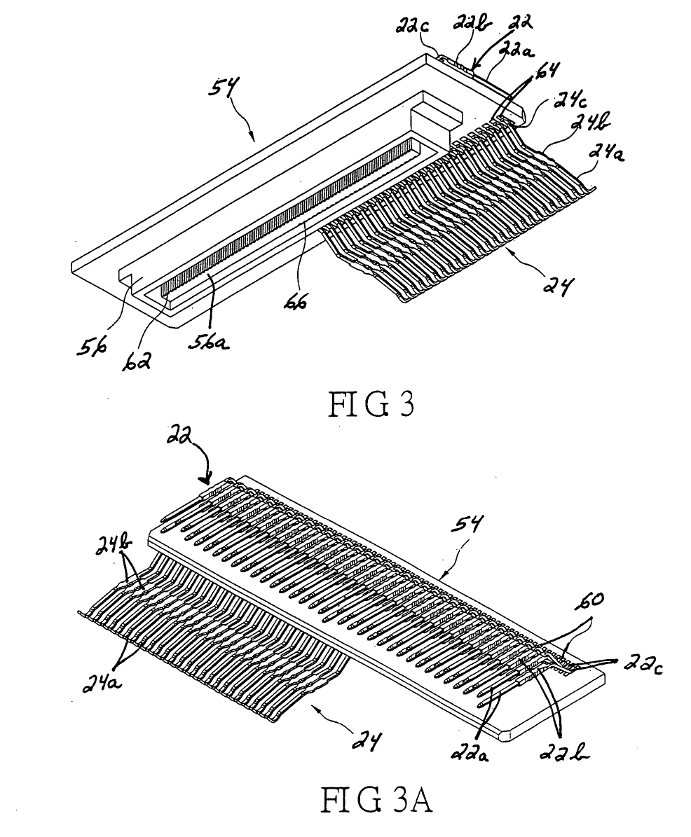

Referring to FIGS. 3 and 3A in conjunction with FIGS. 1 and 2, the invention contemplates an auxiliary printed circuit board, generally designated 54, to which first and second terminals 22 and 24, respectively, are terminated. The auxiliary printed circuit board has an elongated, downwardly projecting mating connector 56 which mates with header connector 14 (FIG. 1) mounted on top surface 12a of the main printed circuit board 12. Specifically, mating connector 56 on the auxiliary printed circuit board has a plug portion 56a for insertion into a receptacle 14a of header connector 14 on the main printed circuit board.

Before proceeding to describe the assembly of auxiliary printed circuit board 54 to housing 20 of connector 10, FIGS. 3 and 3A show details of the first and second terminals 22 and 24, respectively, as terminated to auxiliary printed circuit board 54. Specifically, each first terminal 22 includes a contact portion in the form of a terminal pin 22a insertable into a respective contact hole 16a (FIG. 1) of first memory card 16. Each first terminal includes a central mounting section 22b for insertion into one of the terminal-receiving passages 38 in the rear terminal-mounting section 26 of the housing to fix the terminal in the housing. Each first terminal 22 includes a tail portion 22c for electrical connection, as by soldering, to one of a plurality of circuit traces 60 on a top side of auxiliary printed circuit board 54. Circuit traces 60 are electrically coupled through circuitry on the auxiliary board to a plurality of conductors 62 (FIG. 3) on one side of plug portion 56a of mating connector 56.

Each of the second terminals 24 includes a contact portion 24a which projects into the card-receiving space of housing 20 and for insertion into a contact slot 46a (FIG. 1) of second memory card 18. Each second terminal 24 includes a central mounting section 24b for insertion into a respective one of the terminal-receiving passages 40 in the rear terminal-mounting section of the housing to fix the second terminals in the housing. Each second terminal 24 has a tail portion 24c for electrical connection, as by soldering, to a respective circuit trace 64 (FIG. 3) on the bottom side of auxiliary printed circuit board 54. Circuit traces 64 are electrically coupled through circuitry on the board to a plurality of conductors on a side of plug portion 56a opposite the side of conductors 62.

In summary, FIG. 3A shows that first terminals 22 are arranged in a linear array along the length of elongated auxiliary printed circuit board 54 for electrical connection to a linear array of circuit traces 60 on a top side of the board. FIG. 3 shows that second terminals 24 are arranged in a linear array for electrical connection to a linear array of circuit traces 64 on a bottom side of the auxiliary printed circuit board. It can be seen that the array of first terminals 22 is longer than the array of second terminals 24, corresponding to a longer array of conductors 62 (FIG. 3) on one side of plug portion 56a of mating connector 56 and a shorter array of conductors 66 on the opposite side of the plug portion.

FIG. 1 shows auxiliary printed circuit board 54 mounted to the rear of housing 20 by inserting the end edges of the board into the inwardly facing, opposing slots 34 in the inside facing surfaces of rear side wall sections 32. FIG. 1 also shows supports 42 of the housing beneath the auxiliary printed circuit board to support the center of the board and prevent the board from bending. It can be seen in FIG. 1 how mating connector 56 faces downwardly of the connector for mating with header connector 14 on top surface 12a of the main printed circuit board 12. In particular, plug portion 56a (FIG. 3) of mating connector 56 is inserted into slot 14a of header connector 14.

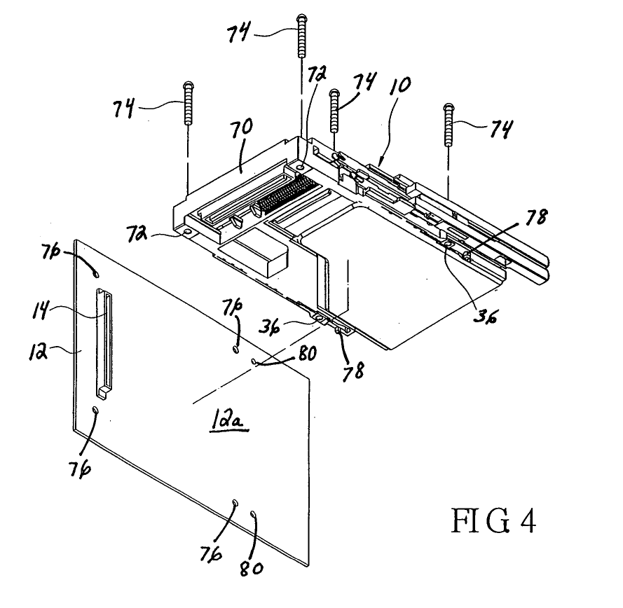

A metal terminal cover 70 is positionable over the rear of housing 20 to both protect the tail portions of the terminals on auxiliary printed circuit board 54 as well as to provide electromagnetic protection for the terminals. The metal terminal cover has holes 72 which are alignable with the through holes 36 which extend vertically through rear side wall sections 32 of the housing. FIG. 4 shows a plurality of fasteners in the form of screws 74 for securing connector 10 to the top surface 12a of main printed circuit board 12. The screws are inserted through holes 36 in the housing as well as holes 72 in metal terminal cover 70 and into screw holes 76 in the main printed circuit board. FIG. 4 also shows that the housing of the connector includes a pair of mounting posts 78 for insertion into a pair of mounting holes 80 in the main printed circuit board.

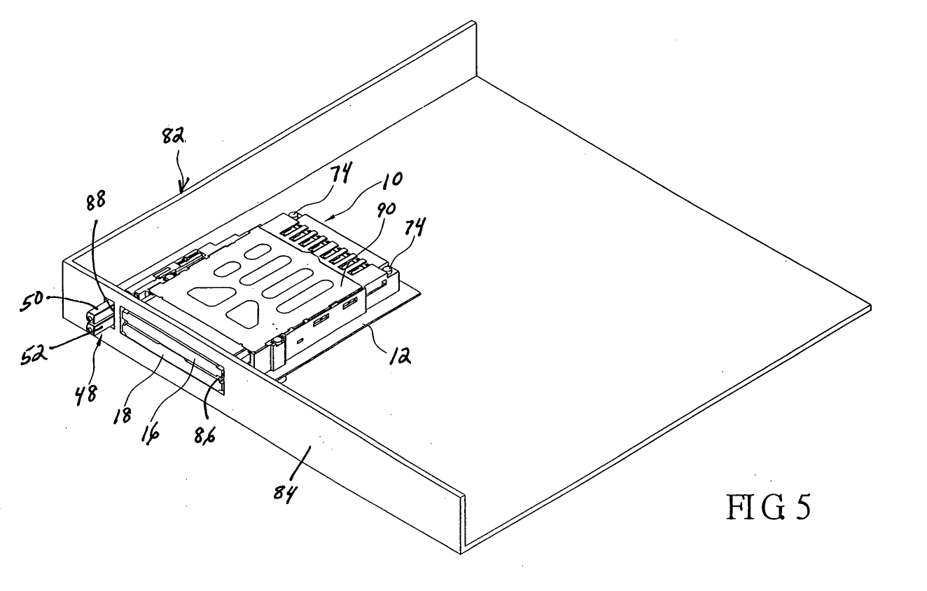

FIG. 5 shows memory card connector 10 mounted in a chassis, generally designated 82, of an electrical appliance. The chassis has an outer wall 84 with an elongated opening 86 and a smaller opening 88. First and second memory cards 16 and 18, respectively, are shown as having been inserted through elongated opening 86 and into memory card connector 10. Ejecting arms 50 and 52 of eject mechanism 48 are shown projecting through opening 88 and exposed for manual manipulation by an operator. Finally, FIG. 5 shows that memory card connector 10 includes a metal top plate 90 which is not visible in the previously described depictions of FIGS. 1-4. The metal plate substantially covers the housing and provides electromagnetic protection for the terminal and contact portions therewithin.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A memory card connector for mounting on a main printed circuit board having a header connector thereon, comprising:
an insulating housing having a rear terminal-mounting section and at least one longitudinal side wall section extending forwardly from one end of the rear section and combining therewith to define a card-receiving space;
an array of first terminals mounted on the rear terminal-mounting section of the housing and having contact portions projecting into said space for engaging appropriate contacts on a first memory card and tail portions exposed on the housing;
an array of second terminals mounted on the rear terminal-mounting section of the housing and having contact portions projecting into said space for engaging appropriate contacts on a second memory card and tail portions exposed on the housing; and
an auxiliary printed circuit board mounted on the housing and having first and second arrays of circuit traces electrically engaged with the tail portions of the first and second terminals, respectively, and electrically coupled to a mating connector on the auxiliary printed circuit board for mating with the header connector on the main printed circuit board.

2. The memory card connector of claim 1 wherein the tail portions of the first terminals are electrically engaged with circuit traces on a top side of the auxiliary printed circuit board, and the tail portions of the second terminals are electrically engaged with circuit traces on a bottom side of the auxiliary printed circuit board.

3. The memory card connector of claim 1 wherein said auxiliary printed circuit board is inserted into slot means at the rear of the housing.

4. The memory card connector of claim 1 wherein said housing includes a pair of rear side wall sections extending rearwardly from opposite ends of the rear terminal-mounting section and between which the auxiliary printed circuit board is mounted.

5. The memory card connector of claim 4 wherein said rear side wall sections have inwardly facing, opposing slots into which the auxiliary printed circuit board is inserted.

6. The memory card connector of claim 1, including a metal baffle plate mounted on the housing in position between a pair of memory cards to provide electromagnetic interference protection between the memory cards.

7. The memory card connector of claim 1 wherein said housing includes a plurality of through holes, and including a plurality of fasteners for penetrating the through holes and fixing the connector to the main printed circuit board.

8. The memory card connector of claim 1, including a metal terminal cover mounted over the rear of the housing.

9. The memory card connector of claim 8 wherein said auxiliary printed circuit board is mounted inside said metal terminal cover.

10. A memory card connector for mounting on a main printed circuit board having a header connector thereon, comprising:
an insulating housing having a rear terminal-mounting section and at least one longitudinal side wall section extending forwardly from one end of the rear section and combining therewith to define a card-receiving space;
an array of terminals mounted on the rear terminal-mounting section of the housing and having contact portions projecting into said space for engaging appropriate contacts on a memory card and tail portions exposed on the housing; and
an auxiliary printed circuit board mounted on the housing and having an array of circuit traces electrically engaged with the tail portions of the terminals and electrically coupled to a mating connector on the auxiliary printed circuit board for mating with the header connector on the main circuit board.

11. The memory card connector of claim 10 wherein said auxiliary printed circuit board is inserted into slot means at the rear of the housing.

12. The memory card connector of claim 10 wherein said housing includes a pair of rear side wall sections extending rearwardly from opposite ends of the rear terminal-mounting section and between which the auxiliary printed circuit board is mounted.

13. The memory card connector of claim 12 wherein said rear side wall sections have inwardly facing, opposing slots into which the auxiliary printed circuit board is inserted.

14. The memory card connector of claim 10 wherein said housing includes a plurality of through holes, and including a plurality of fasteners for penetrating the through holes and fixing the connector to the main printed circuit board.

15. The memory card connector of claim 10, including a metal terminal cover mounted over the rear of the housing.

16. The memory card connector of claim 15 wherein said auxiliary printed circuit board is mounted inside said metal terminal cover.
